(19) United States
(12) Patent Application Publication
(10) Pub. No.: US 2007/0012167 A1
(43) Pub. Date: Jan. 18, 2007

(54) Apparatus, method, and medium for producing motion-generated sound

(75) Inventors: Won-chul Bang, Seongnam-si (KR); Dong-yoon Kim, Seoul (KR); Eun-kwang Ki, Seoul (KR); Sung-jung Cho, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/449,612

(22) Filed: Jun. 9, 2006

(30) Foreign Application Priority Data
Jul. 15, 2005 (KR) 10-2005-0064451

(51) Int. Cl. G10H 3/00

(52) U.S. Cl. 84/723

(57) ABSTRACT

An apparatus, method, and medium for producing motion-generated sound is disclosed, in which a sound that corresponds to a specified direction is output when a motion detected by a motion sensor is a motion in the specified direction. The apparatus includes a motion input unit receiving an input motion, a detection unit detecting a direction of the input motion, a sound extraction unit extracting sound corresponding to the detected direction of motion, and an output unit outputting the extracted sound.

### CROSS-REFERENCE TO RELATED APPLICATIONS

This application claims the benefit of Korean Application No. 10-2005-0064451, filed Jul. 15, 2005, in the Korean Intellectual Property Office, the disclosure of which is incorporated herein by reference.

### BACKGROUND OF THE INVENTION

1. Field of the Invention

The present invention relates to an apparatus, method, and medium for generating sounds according to motions and, more particularly, to an apparatus, method, and medium, which outputs a sound that corresponds to a specified direction if a motion detected by a motion sensor is a motion in the specified direction.

2. Description of the Related Art

An inertial sensor is a device for measuring the inertial force on a object generated by an acceleration or rotational motion by measuring the deformation of an elastic structure connected with the object, and indicating the deformation of the structure as an electrical signal using a detection and signal-processing method.

With the development of micro-mechanical systems using semiconductor processes, the miniaturization and mass production of inertial sensors have become possible. Inertial sensors are generally classified into acceleration sensors and angular velocity sensors, and are used in various applied fields; for example, they are used to control the position and attitude of a ubiquitous robotic companion (URC). At present, the inertial sensor is being applied to the integrated control of vehicular suspension and brake systems, air bags, and car navigation systems. Moreover, they can be used in portable navigation systems, and data input units of portable information appliances such as wearable computers, personal digital assistants (PDAs), and others.

In the aerospace field, they can be applied to navigation systems of aircrafts, missile attitude control systems, military personal navigation systems, and others. Recently, they have been adapted to mobile phones to achieve consecutive motion recognition and to enjoy 3-D games. Mobile phones with inertial sensors are now commonly available.

A mobile phone has been proposed which plays percussion instrument sounds according to the motion of the phone. In the above mobile phone, an integrated inertial sensor recognizes the motions of the phone and outputs pre-stored percussion instrument sounds. Here, a user can select the type of percussion instrument. To data, an acceleration sensor has been used because of its small size and low price.

An apparatus has been proposed which outputs sounds according to motion detection by a sensor. U.S. Pat. No. 5,125,313 discloses an apparatus for outputting sounds according to user's motions, in which the sensor is attached to a portion of the user's body to detect the user's motions in order to output corresponding sounds. In this case, the user's motion may include holding, touching, beating, depressing, pulling, lifting up, lifting down, and others. To output sounds according to the user's motions, recognition of the respective motions should have a high detection precision, which may increase the cost of the device. In addition, it is inconvenient for a user to carry it, and it is difficult for the user to generate desired sounds because of the complexity of the entire system.

### SUMMARY OF THE INVENTION

Additional aspects, features, and/or advantages of the invention will be set forth in part in the description which follows and, in part, will be apparent from the description, or may be learned by practice of the invention.

Accordingly, the present invention has been made to solve the above-mentioned problems occurring in the prior art, and one of the features of the present invention is to output sound corresponding to a specified direction when a motion detected by a motion sensor is in the specified direction.

Another feature of the present invention is to divide a motion detected by a motion sensor into a sound-generation motion and a return motion, and to not output sound for the return motion.

Additional advantages, aspects, and features of the invention will be set forth in part in the description which follows and in part will become apparent to those having ordinary skill in the art upon examination of the following, or may be learned from practice of the invention.

According to another aspect of the present invention, there is provided an apparatus for generating sounds according to motions, according to the present invention, which includes a motion input unit for receiving a motion input; a detection unit for detecting a direction of the input motion; a sound extraction unit for extracting sound corresponding to the detected motion direction; and an output unit for outputting the extracted sound.

In another aspect of the present invention, there is provided a method of generating sounds according to motions, which includes the steps of receiving an input of a motion; detecting a direction of the input motion; extracting sound corresponding to the detected motion direction; and outputting the extracted sound.

In another aspect of the present invention, there is provided at least one computer readable medium storing instructions that control at least one processor to perform a method of producing motion-generated sound, the method including a motion input unit receiving an input motion; a detection unit detecting a direction of the input motion; a sound extraction unit extracting sound corresponding to the detected motion direction; and an output unit outputting the extracted sound.

In another aspect of the present invention, there is provided an apparatus for producing motion-generated sound including a detection unit detecting a direction of motion of the apparatus; a sound extraction unit extracting sound corresponding to the detected motion direction; and an output unit outputting the extracted sound.

In another aspect of the present invention, there is provided a method of producing motion-generated sound from a motion of a device producing the motion-generated sound including detecting a direction of motion of the device; extracting sound corresponding to the detected motion direction; and outputting the extracted sound.

In another aspect of the present invention, there is provided at least one computer readable medium storing instructions that control at least one processor to perform a method of producing motion-generated sound from a motion of a device producing the motion-generated sound, the method including detecting a direction of motion of the device; extracting sound corresponding to the detected motion direction; and outputting the extracted sound.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a conceptual view illustrating an apparatus for producing motion-generated sound according in an exemplary embodiment of the present invention;

FIG. 2 is a block diagram illustrating an apparatus for producing motion-generated sound according to an exemplary embodiment of the present invention;

FIG. 3a and FIG. 3b are views illustrating a relation between motions and corresponding accelerations according to an exemplary embodiment of the present invention;

FIG. 4a and FIG. 4b are views illustrating a relation between motions and corresponding angular velocities according to an exemplary embodiment of the present invention;

FIG. 5a and FIG. 5b are views illustrating a sound-generation state according to consecutive motion;

FIG. 6 is a view illustrating a state where a motion direction is detected by a motion-direction detection unit according to an exemplary embodiment of the present invention;

FIG. 7 is a view illustrating a direction table according to an exemplary embodiment of the present invention;

FIG. 8 is a view illustrating a state where the kind of motion is recognized by a motion recognition unit according to an exemplary embodiment of the present invention;

FIG. 9 is a view illustrating a sound table according to an exemplary embodiment of the present invention;

FIG. 10 is a flowchart illustrating a process of producing motion-generated sound according to an exemplary embodiment of the present invention;

FIG. 11 is a flowchart illustrating a process of detecting a motion direction performed by a motion-direction detection unit according to an exemplary embodiment of the present invention; and

FIG. 12 is a flowchart illustrating a process of recognizing the kind of motion performed by a motion recognition unit according to an exemplary embodiment of the present invention.

### DETAILED DESCRIPTION OF THE PREFERRED EMBODIMENTS

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

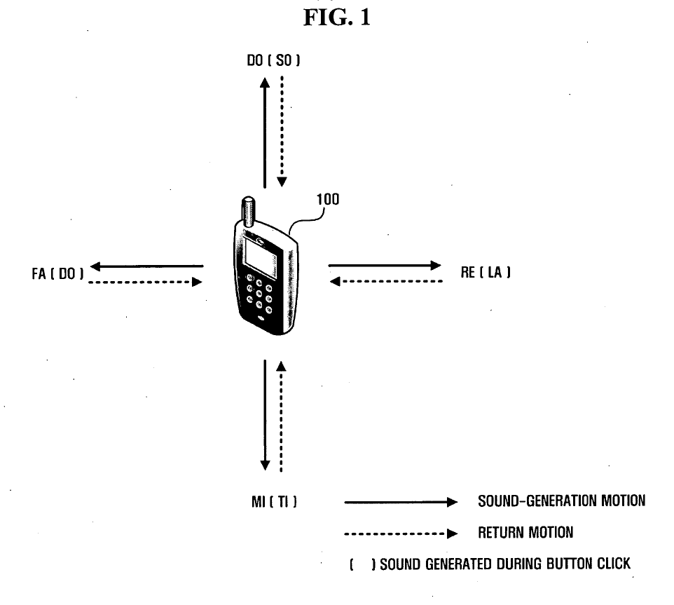

FIG. 1 is a conceptual view illustrating an apparatus for producing motion-generated sound according to an exemplary embodiment of the present invention. The apparatus 100 includes a motion sensor and a sound output means, and may be a personal digital assistant (PDA), an Moving Pictures Expert Group Layer-3 (MP3) player, or other electronic computing devices.

A user can make the apparatus output sounds in a specified direction by moving the apparatus 100 in the specified direction. For example, if upward, right, downward, and left movements respectively correspond to the musical scales of “do”, “re”, “mi”, and “fa”, the user can generate “do” and “re” notes through upward and right movements of the apparatus 100, respectively.

In order to output an octave of 8 notes, the apparatus 100 may be provided with a specified button. The button serves to output other notes corresponding to the respective directions. For example, when the apparatus 100 is moved in a state where the user is pressing the button, the notes of “so”, “la”, “ti”, and do are outputted, instead of the notes “do”, “re”, “mi”, and “fa”.

Alternatively, the apparatus 100 may detect combined directions in order to output all eight notes. That is, in addition to the upward, right, downward, and left movements, upper right, lower right, lower left, and upper left movements may be included. Accordingly, the apparatus can detect 8 directions to output 8 notes without the button.

Further, the apparatus 100 can output sounds according to consecutive motions, and to this end, it divides the respective motion into a sound-generation motion and a return motion. The apparatus outputs the corresponding sound only for the sound-generation motion, and does not output sound for the return motion.

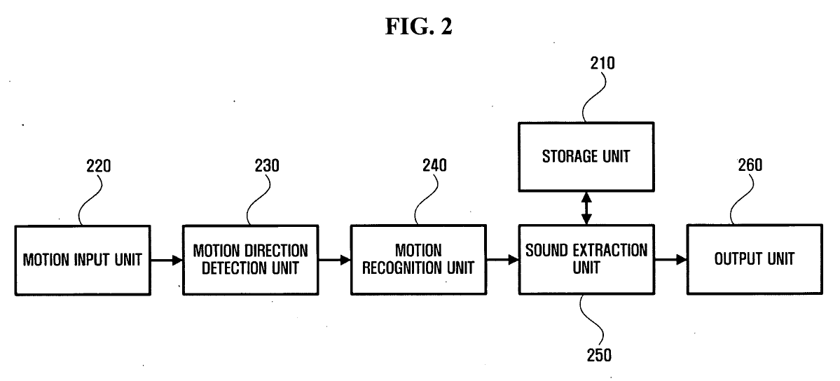

FIG. 2 is a block diagram illustrating an apparatus for producing motion-generated sound according to an exemplary embodiment of the present invention. The apparatus includes a storage unit 210, a motion input unit 220, a motion-direction detection unit 230, a motion recognition unit 240, a sound extraction unit 250, and an output unit 260.

The storage unit 210 serves to store sound sources for outputting sounds. Here, real sound data, processed sound data, user-inputted sound data, and chord sound data.

Real sound data is data obtained by recording and converting sounds produced by an instrument into digital data of a certain format (e.g., wav, mps,). The sound data may be data processed by the user. The sound data may be data obtained by storing therein only a reference sound, rather than all of sounds of the key. That is, in C major, only the sound source corresponding to “do” is stored therein. In this case, the sound extraction unit 250 may extract the reference sound stored in the storage unit 210 and adjust the pitch in order to output the corresponding sound.

The processed sound data may be, for example, musical instrument digital interface (MIDI) data.

The user-inputted sound data inputted is similar to real sound data, and the user can input a sound effect instead of a specified sound. Accordingly, the apparatus can carry out a function of a percussion instrument or special instrument as well as a function of a melody instrument outputting motion-generated sound.

The chord sound data may correspond to a direction of motion. For example, if the sound corresponding to the motion direction is “do”, the sounds of “do”, “mi”, and “so” that correspond to the C chord can be simultaneously extracted. Accordingly, the user can play a chord by moving the apparatus 100.

The motion input unit 220 serves to receive the motion. Here, the motion includes at least one of acceleration and angular velocity. That is, the motion input unit 220 may be an acceleration sensor or an angular velocity sensor (hereinafter, referred to as a “motion sensor”) for detecting an acceleration or an angular velocity.

Here, the motion input unit 220 preferably includes at least a bi-axial motion sensor for receiving motions along at least two axes in a space, in order to receive motions for 8 notes of one octave.

For example, since the motion sensor 220 with the bi-axial motion sensor receives bi-directional motions (positive/negative directions) for two axes, which are perpendicular to each other, the motion sensor can receive four motions corresponding to a total of four notes. Further, it can receive the motions corresponding to four other notes using a specified button provided on the apparatus 100.

In other words, in a state where the button is not pushed, the four directions correspond to “do”, “re”, “mi”, and “fa”, respectively, and in a state where the button is pushed, the directions correspond to “so”, “la”, “ti”, and “do”. To this end, the apparatus 100 may have a button for changing an output sound.

In addition, the motions corresponding to four or more directions can be inputted to the motion input unit 220 with the bi-axial motion sensor, through a combination of the measured motion directions along the respective axes. For example, if the four directions correspond to up, down, left, and right, upper left, upper right, lower left, and lower right motions can be received. Accordingly, the total number of directions that the motion input unit 220 can receive is 8, so that the motion input unit 220 can receive motions completing one octave.

The motion signal inputted to the motion input unit 220 is transferred to the motion-direction detection unit 230. That is, all the motion signals detected by all the motion sensors provided in the motion input unit 220 are transferred to the motion-direction detection unit 230.

The motion-direction detection unit 230 serves to detect the motion directions through the analysis of motion signals transferred from the motion input unit 220.

The motion signals detected by the motion sensors may be the amounts of acceleration or angular velocity for the motion along the specified direction. For example, in the case where the apparatus 100 moves from a reference point to point A, on the assumption that point A and B point are on one axis with the reference point positioned therebetween, and the motion sensor detects the amounts of acceleration, the acceleration at the time when the apparatus 100 moves from the reference point (hereinafter, referred to as “movement acceleration”) and the acceleration at the time when it stops at a target point (hereinafter, referred to as “stoppage acceleration”), which are opposite to each other, are maximums. Further, when the apparatus 100 moves from the reference point to point B, the accelerations at both times (when it moves from the reference point and when it stops at the target point), which are opposite to each other, are maximums.

At this time, it can be seen that the accelerations are opposite in direction to each other when the apparatus moves to point A and point B. The motion-direction detection unit 230 can detect the direction of motion from the change of accelerations. The detailed explanation thereof will be described later with reference to FIG. 2a and FIG. 2b.

On the other hand, in the case where the apparatus 100 moves from the reference point to point A, on the assumption that point A and point B are provided on one axis with a reference point positioned therebetween, and the motion sensor detects the amounts of angular velocity, the angular velocity becomes a maximum during the movement of the apparatus, and it becomes a minimum at the reference point and point A. Further, when the apparatus 100 moves from the reference point to point B, the angular velocity becomes a maximum during the movement, and it becomes a minimum at the reference point and point B.

At this time, it can be seen that the angular velocities are opposite in direction to each other when the apparatus moves from point A to point B. The motion-direction detection unit 230 can detect the direction of motion from the change of in the angular velocities. That is, the detection unit 230 detects the direction of motion through the amounts of acceleration and angular velocity, and the detected direction of motion is transferred to the motion recognition unit 240.

The motion recognition unit 240 serves to check whether the motion inputted by the motion sensor is a sound-generation motion or a return motion with reference to the transferred motion direction.

The user can generate the sound by exerting moving the apparatus 100. The action may be in 4 or 8 directions. Here, if it is intended to repeat the same sound two or more times, the apparatus 100 should be moved in the same direction several times. To prevent this inconvenience, a method of returning to a reference point after the sound-generation motion is used. Accordingly, the apparatus 100 should generate sound when it moves only in a direction from a reference position (initial position). The motion in the predetermined direction is called a “sound-generation motion”, whereas the returning motion (to the reference position) after the sound generation is called a “return motion”.

The motion recognition unit 240 may have a timer, which is reset at the time when a motion code is inputted, and reset again after a specified time. Here, if a motion code is received again before the timer is reset after input of a motion code, the motion recognition unit 240 considers this a return motion. In addition, the motion recognition unit 240 considers the motion code received after reset as a sound-generation motion.

That is, the motion recognition unit 240 can determine the kind of motions, i.e., the sound-generation motion and the return motion, using the timer. Further, the motion recognition unit 240 can refer to the motion signal or the motion direction inputted when determining the kind of motions.

The result recognized by the motion recognition unit 240 is transferred to the sound extraction unit 250, which in turn serves to extract from the storage unit 210 the sound corresponding to the direction of motion with reference to the transferred result of the recognition.

As set forth above, the storage unit 210 may store the sounds of various sound sources, and the sound extraction unit 250 extracts the sound corresponding to the direction of motion among the predetermined sounds. At this time, the sound extraction unit 250 can extract different sounds according to a button input.

Also, the user may set a key, and the sound extraction unit 250 may extract the sound included in the scale according to the key. For example, if the key of C major is set, the notes of “do”, “re”, “mi”, “fa”, “so”, “la”, “ti”, and “do” can be extracted depending on the respective directions. If the key of F major is set, the notes of “do”, “re”, “mi”, “fa-sharp”, “so”, “la”, “ti”, and “do” can be extracted depending on the respective directions.

In addition, the user may set the device so that the sound extraction unit 250 extracts a chord. That is, the sound extraction unit 250 can extract a chord having the sound corresponding to the direction of the corresponding motion as a root. For example, if the sound corresponding to the direction of the motion inputted by the motion sensor is “do”, the sound extraction unit 250 simultaneously extracts “do”, “mi”, and “so” that constitute a major chord having “do” as the root. The sound extraction unit 250 can extract the sound corresponding to a minor chord according to the input of the specified button. For example, if the sound corresponding to the direction of the motion inputted by the motion sensor is “do”, the sound extraction unit 250 simultaneously extracts “do”, “mi-flat”, and “so” that constitute a minor chord having “do” as a root.

In addition, the sound extraction unit 250 can gradually reduce the volume of the sound once extracted according to the elapsed time, and prevent the former from being outputted when the latter sound is generated. The volume reduction rate according to the elapsed time, and whether to prevent the former sound from being outputted can be set by the user.

The sound extracted by the sound extraction unit 250 is transferred to the output unit 260, which serves to output the transferred sound. The output unit 260 may be speakers, earphones, headphones, a buzzer, or others.

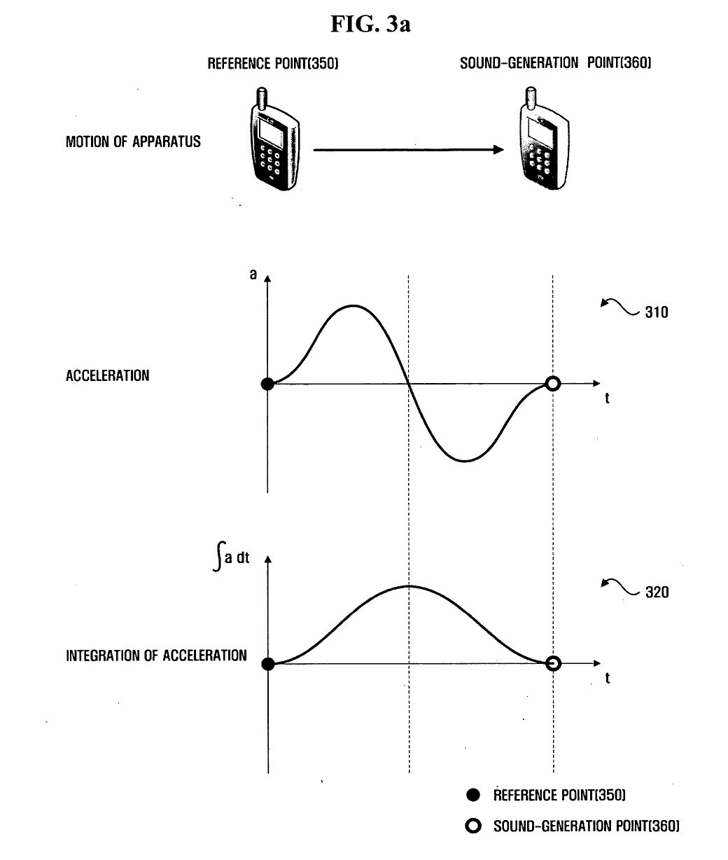

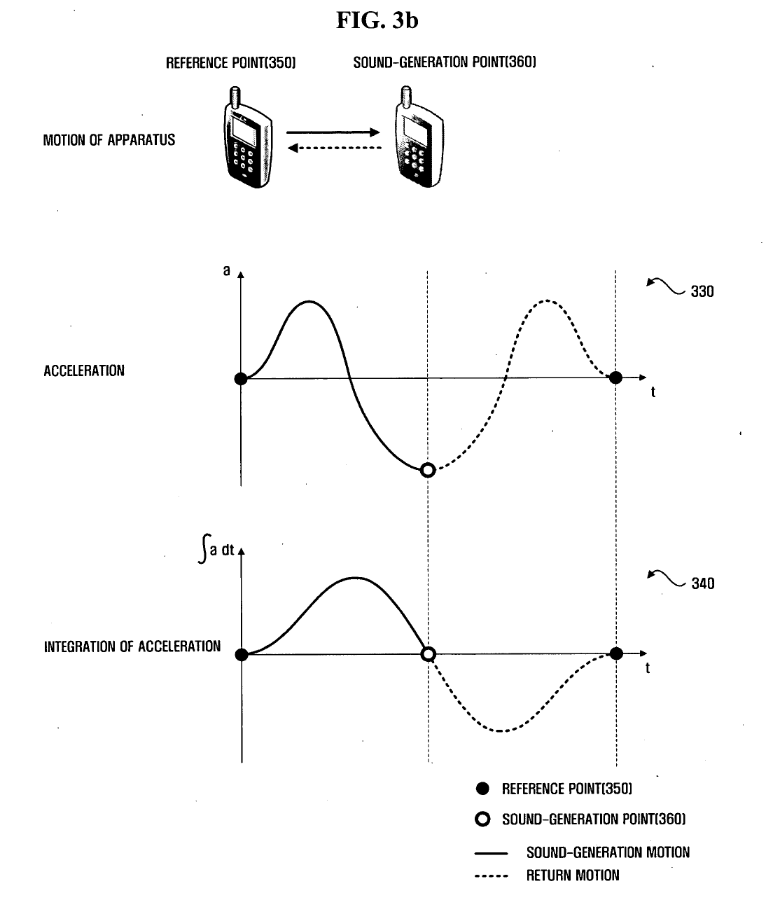

FIG. 3a and FIG. 3b are views illustrating a relation between motions and corresponding accelerations according to an exemplary embodiment of the present invention. In FIG. 3a and FIG. 3b, the motion of the apparatus 100, the acceleration of the apparatus, and the integration in acceleration of the apparatus are illustrated.

For reference, it is assumed that in FIG. 3a and FIG. 3b, only graphs for one axis are shown, and the acceleration in the right direction is positive.

FIG. 3a shows that the apparatus 100 positioned at a reference point 350 moves to the sound generation point 360 positioned on the right side of the reference point 350, and the acceleration thereof and the integrated value of the acceleration are shown in graphs 310 and 320. That is, the magnitude of the acceleration is maximum at the reference point 350 and the sound generation point 360, which are opposite in sign to each other.

In graph 320 indicating the integrated value of the acceleration, the sum is a positive value. Accordingly, the motion-direction detection unit 230 can detect the direction of motion. That is, the motion-direction detection unit 230 finds the sum of the acceleration, and considers that a motion has occurred if the sum exceeds a specified critical value, so that it can detect the direction of motion of the apparatus 100 by checking the sign.

FIG. 3a shows that the apparatus 100 positioned at a reference point 350 moves to the sound generation point 360 positioned to the right of the reference point 350, and returns to the reference point 350, wherein the acceleration thereof and the integrated value of the acceleration are shown in graphs 330 and 340. That is, the magnitude of the acceleration becomes a maximum at the reference point 350 and the sound generation point 360, which are opposite in sign to each other.

In graph 340, the section where the apparatus moves from the reference point 350 to the sound generation point 360 is indicated by a negative value, whereas a section in which the apparatus moves from the sound generation point 360 to the reference point 350 is indicated by a positive value. That is, the values before and after the sound generation have opposite signs to each other, and thus the motion recognition unit 240 can determine the sound-generation motion and the return motion. Here, if the case where the motion that does not successively occur within a specified time after the sound-generation motion occurs, the motion recognition unit 240 may consider it the sound-generation motion rather than the return motion.

For reference, although FIG. 3a and FIG. 3b indicate that the direction of motion, and the sound-generation motion and the return motion are detected, as described above; the apparatus 100 may simultaneously detect the directions of motion of the apparatus 100 operating in a plurality of axes, and the sound-generation motion and the return motion.

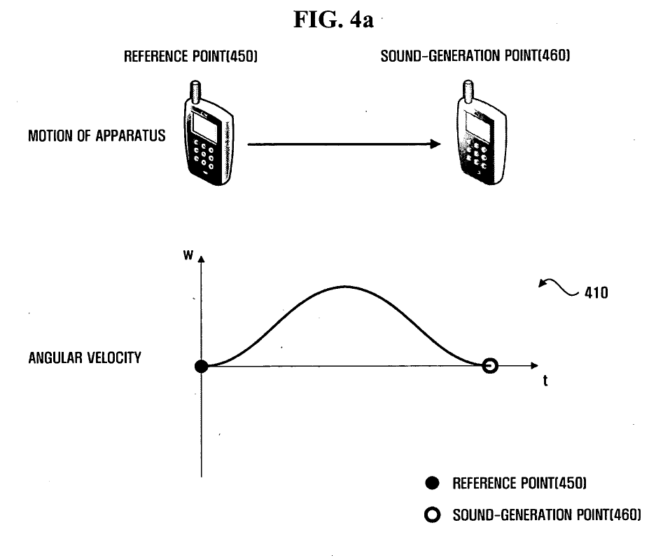

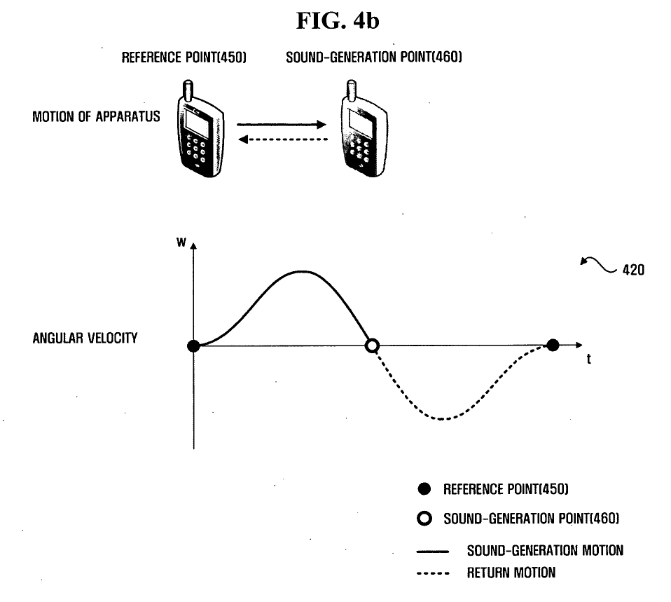

FIG. 4a and 4b are views illustrating a relation between motions and corresponding angular velocities according to an exemplary embodiment of the present invention, which shows the motion of the apparatus 100, the direction of motion, and the angular velocity of the motion.

For reference, in FIG. 4a and 4b, only graphs for one axis are shown, and the angular velocity in the right direction is positive.

FIG. 4a shows that the apparatus 100 positioned at a reference point 450 moves to the sound generation point 460 positioned to the right of the reference point 450, wherein the angular velocity thereof is shown in graph 410. That is, it can be known that the magnitude of the angular velocity is a minimum at the reference point 450 and the sound generation point 460, and the sum of the angular velocities is a positive value.

Accordingly, the motion-direction detection unit 230 can detect the motion direction. That is, the motion-direction detection unit 230 finds the sum of the angular velocity and considers that a motion has occurred if the sum exceeds a specified critical value, so that it can detect the direction of motion of the apparatus 100 on an axis by checking the sign of the value.

FIG. 4b shows that the apparatus 100 positioned at a reference point 450 moves to the sound generation point 460 positioned to the right of the reference point 450, and returns to the reference point 450; the angular velocity of this motion is shown in graph 420. That is, the magnitude of the angular velocity is a minimum at the reference point 450 and the sound generation point 460; a section in which the apparatus moves from the reference point 450 to the sound generation point 460 is indicated by a positive value; and a section in which the apparatus moves from the sound generation point 460 to the reference point 450 is indicated by a negative value. That is, the values before and after the sound generation have opposite signs to each other, whereby the motion recognition unit 240 can determine the sound-generation motion and the return motion. Here, in the case where the motion that does not successively occur within a specified time after the sound-generation motion, but occurs after this time, is considered a sound-generation motion rather than a return motion.

For reference, although FIG. 3a and FIG. 3b show the direction of motion being determined for the apparatus operating in on axis, and the sound-generation motion and the return motion are detected, as described above, the apparatus 100 may extract the directions of motion of the apparatus 100 moving in a plurality of axes, and simultaneously recognize the sound-generation motion and the return motion.

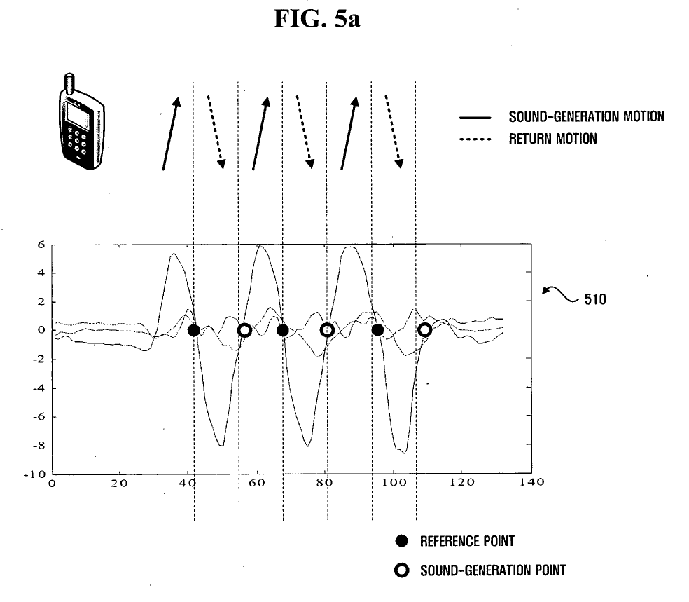

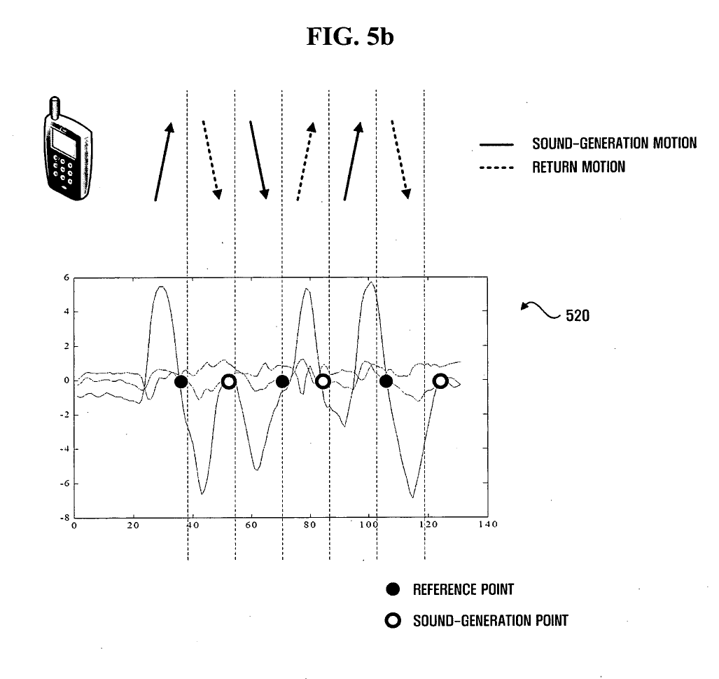

FIG. 5a and FIG. 5b are views illustrating a sound generation state for consecutive motions according to an exemplary embodiment of the present invention; FIG. 5a shows consecutive motions for the same sound, and FIG. 5b shows the consecutive motions for different sounds.

In FIG. 5a and 5b, it is assumed that the apparatus 100 can perceive the motions in four directions perpendicular to each other by using the bi-axial motion sensor, and the four directions of up, down, left, and right correspond to “do”, “re”, “mi”, and “fa”, respectively.

In FIG. 5a, when the user moves the apparatus 100 upward and downward from the reference point, the upward motion corresponds to the sound-generation motion, and the downward motion corresponds to the return motion. A test result of the angular velocity for such motions is shown in a graph 510; the waveform above the time axis represents the sound-generation motion, and the waveform below the axis is the return motion.

Here, a sound generation point is a point where the angular velocity exceeds a specified critical value and then becomes zero again, and the motion recognition unit 240 transfers to the sound extraction unit 250 a message that the sound-generation motion in the corresponding direction has been received. The motion-extraction unit considers the subsequent motion as the return motion, and therefore does not transfer the same message to the sound extraction unit 250. Of course, if the subsequent motion has occurred after a predetermined time, the motion recognition unit 240 considers the motion a sound-generation motion and transfers the message to the sound extraction unit 250.

In FIG. 5b, when the user moves the apparatus 100 upward and downward, downward and upward, and then upward and downward, from the reference point, the motion recognition unit 240 determines whether the motion in the respective direction is the sound-generation motion or the return motion.

That is, in the first upward and downward motion, the upward motion is considered a sound-generation motion, and the downward motion as a return motion. After the return motion, the downward motion is considered a sound-generation motion, and the upward motion is considered a return motion. That is, a reference to determine whether the motion in the same direction is a sound-generation motion, or the return motion is dependent on whether the previous motion is the sound-generation motion or the return motion.

A test result for this is shown in the graph of FIG. 5b. The motion recognition unit 240 can detect the kind of the motions using the waveform of the input motion signal or a motion code transferred from the motion-direction detection unit 230.

The motion recognition unit 240 can perceive the sound-generation motion and the return motion by using a timer as mentioned above. That is, when the subsequent motion is inputted after a predetermined time after the sound-generation motion, the motion recognition unit 240 may consider the subsequent motion as the sound-generation motion.

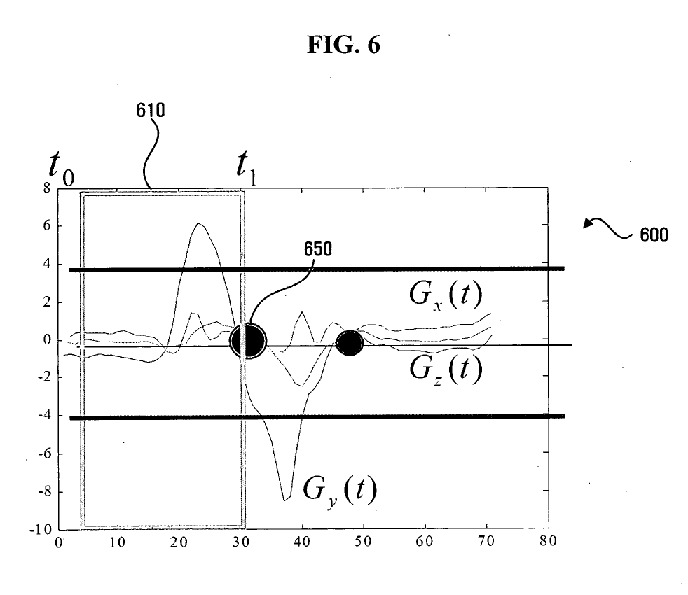

FIG. 6 is a graph 600 illustrating a state where a motion direction is detected by a motion-direction detection unit according to an exemplary embodiment of the present invention, wherein a motion signal G_{y}(t) generated relative to a specified axis among the motion signals Gₓ(t), G_{y}(t), and G_{z}(t) generated relative to the x-, y-, and z-axes, respectively, exceeds a critical value. It can be known therefrom that the motion-direction detection unit 230 has detected a motion generation operation 650 in a section 610.

The motion-direction detection unit 230 finds the sum of the motion signals (the quantity of angular velocity) inputted for a specified time, and when a motion signal exceeding a specified critical value is generated, and perceives it as the sound-generation motion 650. The motion signal may be one or more received signals. The sum of the motion signals can be expressed by the following equation.

$$a = {max}_{b ∈ \{ x , y , z \}} {\sum }_{k = {t}_{0}}^{{t}_{1}} {G}_{b} ( k )$$

Here, a denotes an axis having the sum of the maximum motion signals, t₀ denotes the beginning of the detection time and t₁ denotes the end of the detection time, and G(k) denotes the motion signals (the quantity of angular velocity) of the respective axes.

After the sum of the maximum motion signals is found, the motion-direction detection unit 230 checks the sign of the sum of the maximum motion signals to determine the corresponding direction. To this end, a table having direction information on the signs of the respective axes can be referred to; this table may be stored in the storage unit 210.

FIG. 6 shows motion signals of the x-, y-, and z-axes, wherein the motion signal of y-axis is a maximum. The motion-direction detection unit 230 finds the sum of the respective motion signals to check that the motion signal of y-axis is a maximum, and the sign of the sum is positive. The detection unit refers to the above-mentioned direction table to check the direction of y-axis with the positive value, and transfers the result of the check to the motion recognition unit 240.

The motion-direction detection unit 230 may detect a direction according to a ratio of the magnitude of the motion of one or more axes among the spatial axes. Using a ratio of the respective axes in a space defined by the plurality of axes, the apparatus 100 can output various kinds of sound according to the motion.

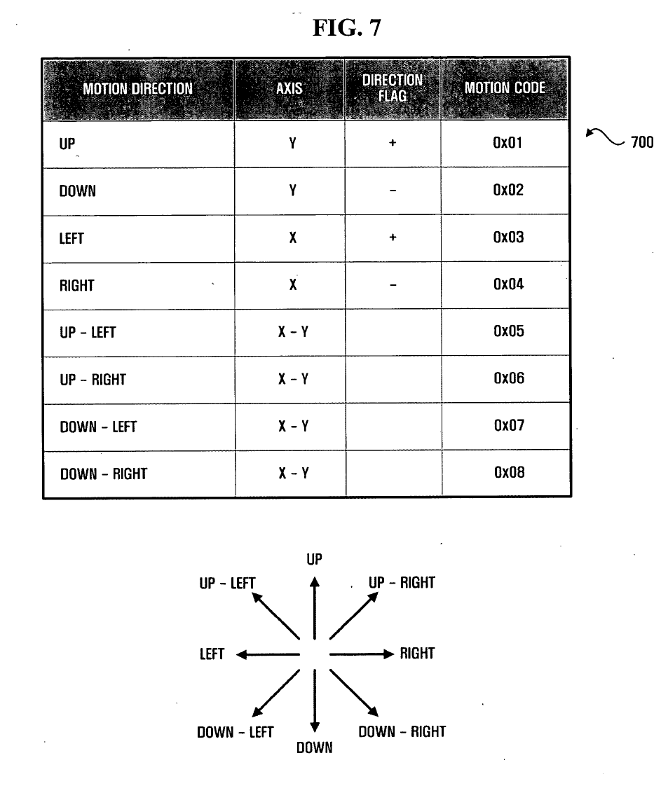

FIG. 7 shows a direction table 700 according to an exemplary embodiment of the present invention, which includes axes, direction flags, and motion codes created by a motion sensor.

The axis defined by the motion sensor is an axis detected by the motion sensor provided on the apparatus 100, the number of which is determined by the number of motion sensors. Here, if there are two motion sensors, the motions in four directions, i.e., up, down, left, and right, can be detected. If there are three motion sensors, motions in six directions, i.e., up, down, left, right, forward, and backward can be detected.

In addition, the directions of the motions detected by the plurality of motion sensors can be combined and detected. For example, if there are two motion sensors, the upper left, upper right, lower left, and lower right movements can also be detected in addition to the upward, downward, left, and right movements.

Similarly, when there are three motion sensors, three-dimensional motion can be detected.

The direction flag indicates a direction on the corresponding axis. For example, the direction flag determines the upward or downward direction on the axis connecting the upper and lower spaces.

The motion code indicates a characteristic code for the corresponding direction of motion. The direction of motion detected by the motion-direction detection unit 230 is transferred to the motion recognition unit 240 in the form of a motion code.

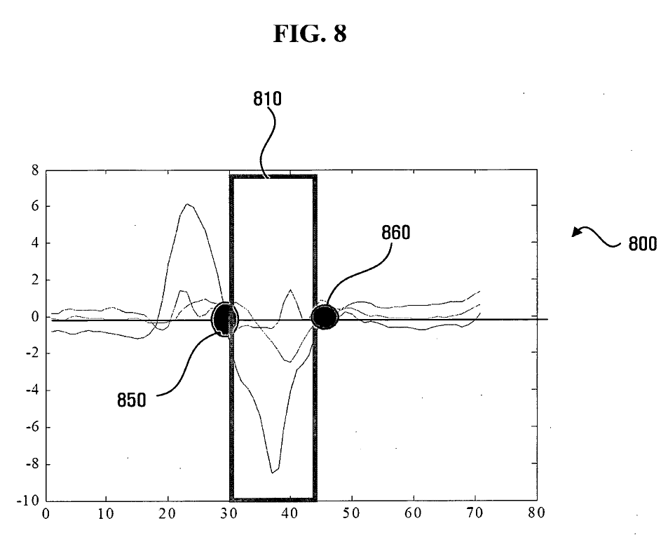

FIG. 8 is a graph 800 illustrating a state where the kinds of motion are recognized by a motion recognition unit according to an exemplary embodiment of the present invention, wherein a motion signal G_{y}(t) generated relative to a specified axis among the motion signals Gₓ(t), G_{y}(t), and G_{z}(t) generated relative to the x-, y-, and z-axes, respectively, exceeds a critical value. The motion recognition unit 240 recognizes a return motion 860 by a section 810 in which a motion signal is inputted after a sound-generation motion 850.

The motion recognition unit 240 perceives the initial motion as the sound-generation motion 850, and the subsequent motion as the return motion 860. Here, the initial motion is the motion received in a state where a motion is not inputted for a specified time, and a timer for measuring the time may be integrated in the motion recognition unit 240.

After the receipt of the initial motion, the timer of the motion recognition unit 240 is reset in order to measure a time interval up to the subsequent motion. If the subsequent motion occurs within a specified time, the motion is considered a return motion 860, and if not, the timer is reset again.

In addition, the motion recognition unit 240 can perceive the sound-generation motion and the return motion 860 using an input motion signal such that if the input motion signal exceeds a specified critical value when it is near the origin for a specified time, the motion signal is perceived as the sound-generation motion. Moreover, if the subsequent motion occurs within a specified time, the motion is considered to be a return motion 860, and if not, the recognition of return motion 860 is terminated. That is, the subsequent motion occurring a specified time after the recognition of a sound-generation motion 850 is considered to be a sound-generation motion 850.

The motion recognition unit 240 can refer to a direction of motion in order to identify the sound-generation motion 850 and the return motion 860. That is, only when the subsequent motion after the recognition of the sound-generation motion 850 is opposite in direction to the sound-generation motion 850, the subsequent motion is considered a return motion 860. For example, in the case of two motions in the same direction, the motion recognition unit 240 considers the second motion inputted within a specified time a sound-generation motion 850, rather than a return motion 860.

Further, in the case where the input motion contains four directions that are the basic directions for two axes, the motion recognition unit 240 may consider the subsequent motion a return motion 860 if a part or the whole of the opposite direction to the sound-generation motion 850 is included in the subsequent motion.

For example, when the sound-generation motion 850 is in the upward direction, and the subsequent motion has downward and left directions, the subsequent motion is considered as a return motion 860 because the downward direction, which is opposite to the sound-generation motion 850, is included in the motion (corresponding to the lower left movement). Similarly, when the sound-generation motion 850 has the direction corresponding to the upper left movement, and the subsequent motion has a right movement, the subsequent motion is considered a return motion 860 because the left direction, which is opposite to the subsequent motion, is included in the motion (corresponding to the upper left movement).

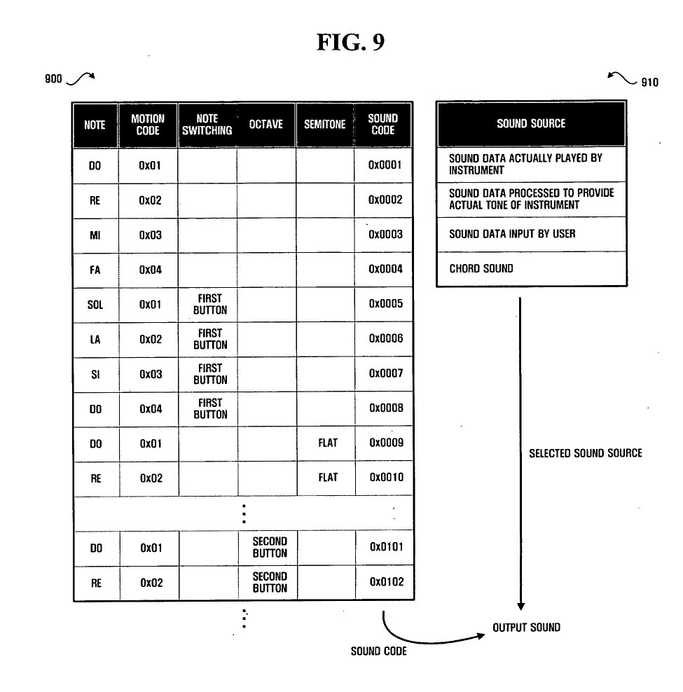

FIG. 9 is a view illustrating a sound table 900 according to an exemplary embodiment of the present invention. The sound table includes notes, motion codes, note switching button states, octave switching button states, chromatic semitones, and sound codes.

The sound extraction unit 250 receives a detection result, which includes motion codes, from the motion recognition unit 240. The sound extraction unit 250 extracts the tones corresponding to the received motion codes with reference to the sound table 900 stored in the storage unit 210.

The apparatus 100 may be provided with a button so that the sound table 900 may include the note switching button states and the octave switching button states. In addition, the semitone states for semitone processing (flat or sharp) may be included in the sound table 900.

The sound extraction unit 250 extracts the sound codes that correspond to the motion codes, the note switching button states, the octave switching button states, and the semitone states, and then extracts the output sounds using a sound source 910 selected by the user.

As described above, the sound source 910 may include only a reference tone, and to this end, the sound extraction unit 250 may be provided with means for adjusting the pitch. The sound extraction unit 250 can extract the corresponding tones using the sound codes and the reference tone.

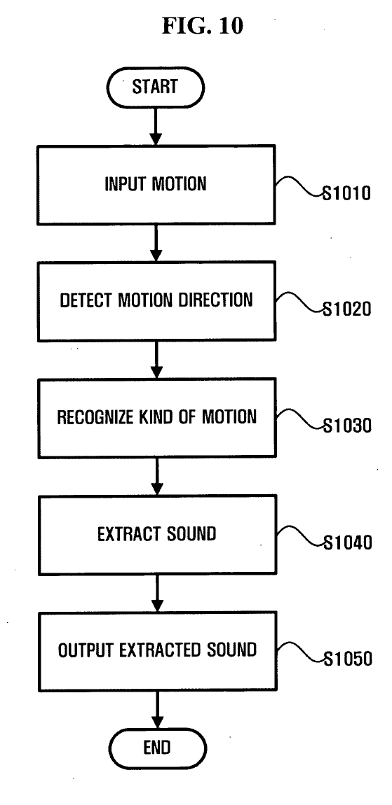

FIG. 10 is a flowchart illustrating a process of producing motion-generated sound according to an exemplary embodiment of the present invention.

The motion input unit 220 of the apparatus 100 first receives an input of motion so as to generate the sound according to the motion S1010. Here, the motion is at least one of an acceleration and angular velocity, and the types of received motion signals can be different according to the type and the number of the sensors provided in the motion input unit 220. Hereinafter, it is assumed that a motion signal is a quantity of angular velocity.

For example, the motion input unit 220 with two motion sensors can receive motion signals in four directions (two axes), and the motion input unit 220 with three motion sensors can receive motion signals in six directions (three axes).

The motion signals, which are signals in any direction, are inputted by the motion input unit 220 are transferred to the motion-direction detection unit 230.

The detection unit 230 detects the directions of motion using the transferred motion signals S1020. For this, the motion-direction detection unit 230 analyzes the motion signals from the respective sensors in such a manner that it finds the sum of the respective motion signals, extracts an axis corresponding to the motion signal whose sum is the largest, and checks whether the sign of the sum is positive or negative, thereby determining the direction of motion.

The checked direction of motion is transferred to the motion recognition unit 240, which in turn recognizes the type motion; that is, whether the input motion is the sound-generation motion or the return motion S1030. In other words, when the motion is received in a state where a motion has not been inputted for a specified time, the motion recognition unit considers it a sound-generation motion, and when the motion occurs subsequent to the sound-generation motion within a specified time, the motion recognition unit considers it a return motion. In addition, if a motion signal is not received for a specified time after the sound-generation motion, a subsequent received motion signal may be considered a sound-generation motion.

When the motion recognition unit 240 recognizes the input motion signal as the sound-generation motion, the motion recognition unit transfers the result to the sound extraction unit 250.

The sound extraction unit 250 refers to the transferred result, i.e., the direction of motion, to extract the sound stored in the storage unit 210 S1040. As described above, the storage unit 210 may store various sound sources, and the sound extracted by the sound extraction unit 250 may be real sound data, processed sound data, user-inputted sound data, or chord sound data.

The extracted sound is transferred to the output unit 260, which in turn outputs the extracted sound S1050.

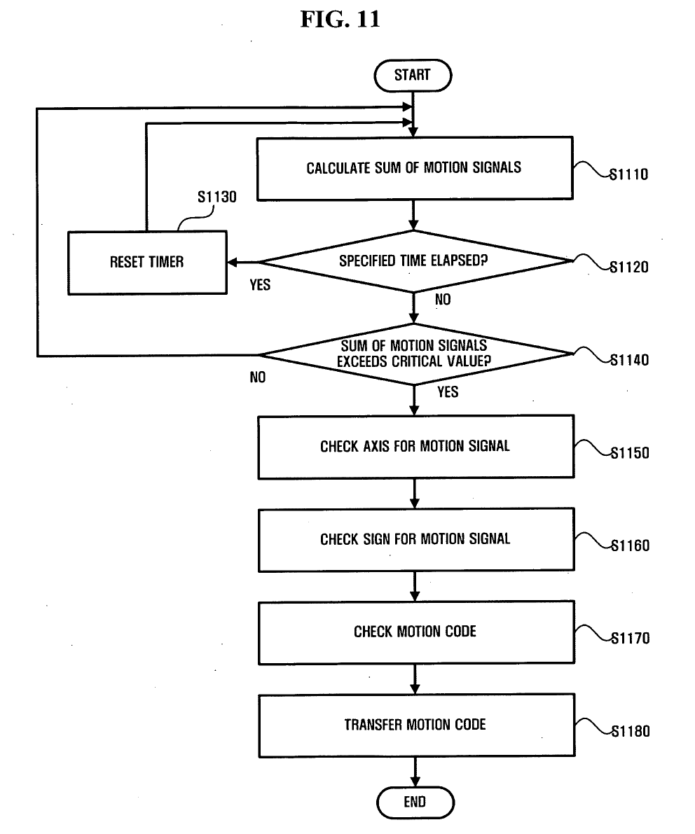

FIG. 11 is a flowchart illustrating a process of detecting a direction of motion performed by a detection unit of motion direction according to an exemplary embodiment of the present invention.

The detection unit 230 finds the sum of the input motion signals S1110. Here, the received motion signal means all motion signals detected by the motion sensor. The detection unit checks whether a specified time has elapsed S1120 and then checks whether the sum of the motion signals has exceeded a specified critical value S1140. That is, the motion detection by the detection unit 230 continues for a specified time, and if the sum of the motion signals does not exceed the critical value for a specified time, the detection unit 230 ignores the calculated value and resets the timer S1130 to calculate the sum of the motion signals inputted again.

Then, when the sum of the motion signal exceeds the critical value, the detection unit checks an axis for the corresponding motion signal S1150 to identify a sign thereof S1160. At this time, the motion signal exceeding the critical value may be the plurality of motion signals, so that the detection unit 230 may check for an axis of the motion signals and a sign thereof.

The detection unit 230 refers to the direction table stored in the storage unit 210 to check a corresponding motion code S1170, and transfers the checked motion code to the motion recognition unit 240 S1180.

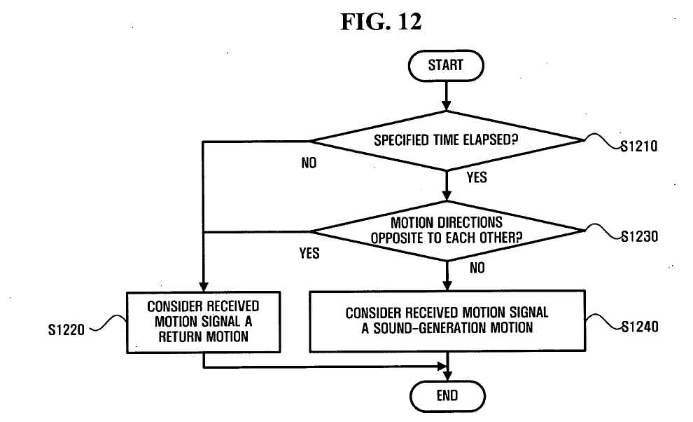

FIG. 12 is a flowchart illustrating a process of recognizing the kind of motions performed by a motion recognition unit according to an exemplary embodiment of the present invention.

The motion recognition unit 240 receives the direction of motion and the motion signal from the detection unit 230 and first checks whether a specified time has elapsed by using a timer S1210. If the specified time has not elapsed after the input of the motion signal, the motion recognition unit considers the present input motion signal a return motion S1220, and if the specified time has already elapsed, the motion recognition unit compares the present input direction of motion with the former direction of motion S1230.

If the directions of motion are opposite to each other, the motion recognition unit considers the present input motion a return motion S1220, and if not, the unit considers it a sound-generation motion S1240.

Here, the input motion may be a combination of directions. That is, if four directions corresponding to up, down, left, and right are detected by the two motion sensors, the input motion may correspond to one of the upper left, upper right, lower left, and lower right movements. In this case, the motion recognition unit 240 compares the components of the present input motion with those of the former input motion such that if an opposite component is included in the comparison result, the motion recognition unit considers the input motion a return motion, and if not, it considers the input motion a sound-generation motion.

For example, when the former input motion is in the up direction, and the present input motion is a combination of down and left, the motion recognition unit 240 considers the present input motion as a return motion because the down direction, which is opposite to the former input motion signal, is included in the present input motion signal. Similarly, when the former input motion is a combined direction corresponding to the upper left movement, and the present input motion signal corresponds to left, the motion recognition unit 240 considers the present input motion signal a sound-generation motion because both the former and present input motion signals have no opposite component.

In addition to the above-described exemplary embodiments, exemplary embodiments of the present invention can also be implemented by executing computer readable code/instructions in/on a medium, e.g., a computer readable medium. The medium can correspond to any medium/media permitting the storing and/or transmission of the computer readable code.

The computer readable code/instructions can be recorded/transferred in/on a medium in a variety of ways, with examples of the medium including magnetic storage media (e.g., floppy disks, hard disks, magnetic tapes, etc.), optical recording media (e.g., CD-ROMs, or DVDs), magneto-optical media (e.g., floptical disks), hardware storage devices (e.g., read only memory media, random access memory media, flash memories, etc.) and storage/transmission media such as carrier waves transmitting signals, which may include instructions, data structures, etc. Examples of storage/transmission media may include wired and/or wireless transmission (such as transmission through the Internet). Examples of wired storage/transmission media may include optical wires and metallic wires. The medium/media may also be a distributed network, so that the computer readable code/instructions is stored/transferred and executed in a distributed fashion. The computer readable code/instructions may be executed by one or more processors.

As described above, the apparatus, method, and medium for producing a motion-generated sound according to the present invention produce one or more of the following effects.

First, when a motion detected by a specified motion sensor is a motion in a specified direction, sound corresponding to the specified direction is outputted, so that various kinds of sound can be outputted even by motions having low precision.

Second, a motion detected by a motion sensor is classified into a sound-generation motion and a return motion, and no sound is outputted during the return motion, so that consecutive sounds can be outputted.

Although a few exemplary embodiments of the present invention have been shown and described, it would be appreciated by those skilled in the art that changes may be made in these exemplary embodiments without departing from the principles and spirit of the invention, the scope of which is defined in the claims and their equivalents.

What is claimed is:

1. An apparatus for producing motion-generated sound, comprising:
a motion input unit receiving an input motion;
a detection unit detecting a direction of the input motion;
a sound extraction unit extracting sound corresponding to the detected motion direction; and
an output unit outputting the extracted sound.

2. The apparatus of claim 1, wherein the motion input unit receives the motion using at least one of an acceleration sensor and an angular velocity sensor.

3. The apparatus of claim 1, wherein the direction of motion is at least one of up, down, left, right, forward, backward and a plurality of combinations of these six directions for three axes in a 3-dimentional space.

4. The apparatus of claim 1, wherein the direction of motion includes a direction according to the ratio of magnitudes of the motions on one or more axes among the spatial axes.

5. The apparatus of claim 1, further comprising a motion recognition unit recognizing whether the input motion is a sound-generation motion or a return motion.

6. The apparatus of claim 5, wherein the sound extraction unit extracts the sound only when the input motion is the sound-generation motion.

7. The apparatus of claim 1, wherein the sound extraction unit adjusts the pitch of the extracted sound according to a predetermined musical scale.

8. The apparatus of claim 1, further comprising a storage unit storing sound sources for the sounds to be extracted.

9. The apparatus of claim 8, wherein the sound source includes at least one of real sound data, processed sound data, user-inputted sound data, and chord sound data.

10. A method of producing motion-generated sound, comprising:
receiving an input motion;
detecting a direction of the input motion;
extracting sound corresponding to the detected motion direction; and
outputting the extracted sound.

11. The method of claim 10, wherein in receiving an input motion, the motion is received using at least one of an acceleration sensor and an angular velocity sensor.

12. The method of claim 10, wherein the direction of motion is at least one of up, down, left, right, forward, backward and a plurality of combinations of these six directions for three axes in a 3-dimentional space.

13. The method of claim 10, wherein the direction of motion includes a direction according to the ratio of magnitudes of the motions on one or more axes among the spatial axes.

14. The method of claim 10, further comprising recognizing whether the input motion is a sound-generation motion or a return motion.

15. The method of claim 14, wherein in extracting sound corresponding to the detected motion direction, the sound is extracted only when the input motion is a sound-generation motion.

16. The method of claim 10, wherein in extracting sound corresponding to the detected motion direction, the pitch of the extracted sound is adjusted according to a predetermined musical scale.

17. The method of claim 10, wherein the sound source is at least one of real sound data, processed sound data, user-inputted sound data, and chord sound data.

18. At least one computer readable medium storing instructions that control at least one processor to perform a method of producing motion-generated sound, the method comprising:
a motion input unit receiving an input motion;
a detection unit detecting a direction of the input motion;
a sound extraction unit extracting sound corresponding to the detected motion direction; and
an output unit outputting the extracted sound.

19. An apparatus for producing motion-generated sound, comprising:
a detection unit detecting a direction of motion of the apparatus;
a sound extraction unit extracting sound corresponding to the detected motion direction; and
an output unit outputting the extracted sound.

20. A method of producing motion-generated sound from a motion of a device producing the motion-generated sound comprising:
detecting a direction of motion of the device;
extracting sound corresponding to the detected motion direction; and
outputting the extracted sound.

21. At least one computer readable medium storing instructions that control at least one processor to perform a method of producing motion-generated sound from a motion of a device producing the motion-generated sound, the method comprising:
detecting a direction of motion of the device;
extracting sound corresponding to the detected motion direction; and
outputting the extracted sound.
